(19) United States
(12) Patent Application Publication
(10) Pub. No.: US 2012/0017395 A1
(43) Pub. Date: Jan. 26, 2012

(54) Triple-Tooth Weld-On Hinge

(76) Inventor: Liang Huachun, Bazhou City (CN)

(21) Appl. No.: 13/174,512

(22) Filed: Jun. 30, 2011

(30) Foreign Application Priority Data
Jun. 30, 2010 (CN) 201020241902.1

(51) Int. Cl. E05D 5/02

(52) U.S. Cl. 16/382

(57) ABSTRACT

A triple-tooth weld-on hinge includes a cradle plate, connector spinal plate, crowfoot wrench, riveting pin, connector plate, and spring. The cradle plate, connector spinal plate, and crowfoot wrench are connected through the connector plate and secured with the riveting pin. The bottom is joined by the spring. The range of movement between the cradle plate and the connector spinal plate is between σ1-σ2, or between 105° and 125°. The hinge can be used for securing furniture, particularly steel-framed sofas, as it allows for three angled adjustments between the seats and backs of the sofas. With the various insertion slots on the spinal plate, riveting piece, and cradle plate, the steel-framed sofas can be adjusted to different dimensions.

### FIELD OF THE INVENTION

The invention relates to the field of hinges and, more specifically, to hinges that allow for the adjustment of the angle between the seat and back of a steel-framed sofa.

### BACKGROUND OF THE INVENTION

Although existing sofas are rather advanced in their specifications and styles, most sofas, even high-end ones, possess only fixed seatbacks that do not allow for angle adjustment.

### SUMMARY OF THE INVENTION

The invention is a triple-tooth hinge that allows for sofa seatback adjustment comprising a cradle plate, connector spinal plate, crowfoot wrench, riveting pin, connector plate, and spring. The cradle plate, connector spinal plate, and crowfoot wrench are connected through the connector plate and secured with the riveting pin. The bottom is joined by the spring.

The range of movement between the cradle plate and the connector spinal plate is approximately 105°-125°.

The hinge can be used for securing furniture, particularly steel-framed sofas, as it allows for three angle adjustments between the seats and backs of the sofas. With the various insertion slots on the spinal plate, riveting piece, and cradle plate, the steel-framed sofas can be adjusted to different dimensions.

### FIGURES

The detailed description is described with reference to the following set of drawings. The same reference numerals provided on different drawings indicate the same or similar items. Other advantages and aspects of the invention will become apparent upon reading the following description of the drawings and

### DETAILED DESCRIPTION

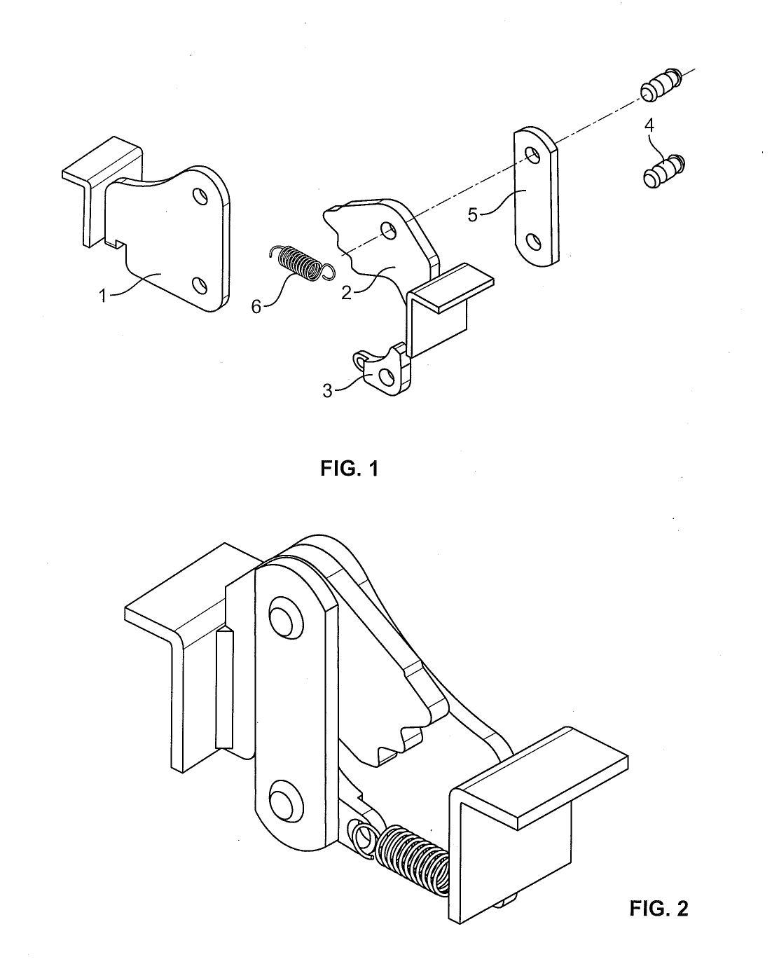

FIG. 1 is a diagram of the triple-tooth hinge according to an example embodiment of the invention;

FIG. 2 is a side view of the hinge in a horizontal position according to another example embodiment of the invention;

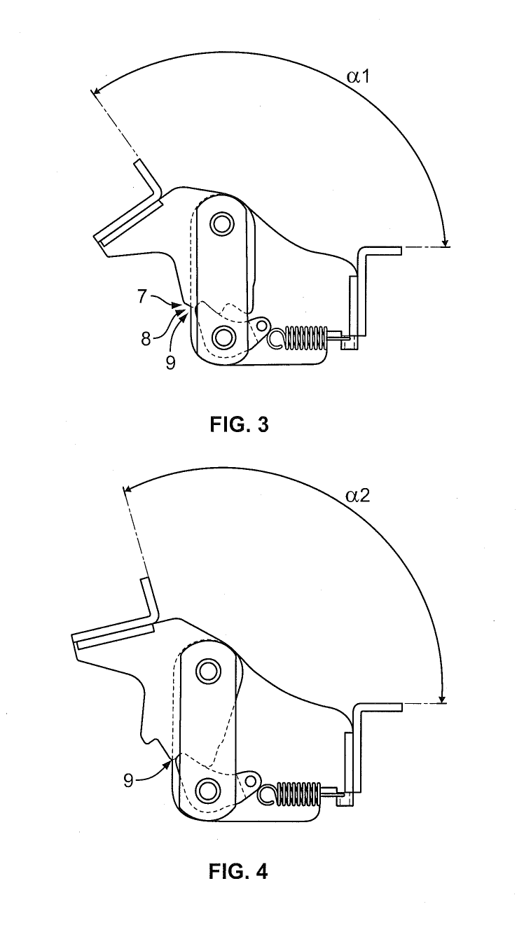

FIG. 3 is a front view of the hinge in a first position according to another example embodiment of the invention;

FIG. 4 is a front view of the hinge in a second position according to another example embodiment of the invention;

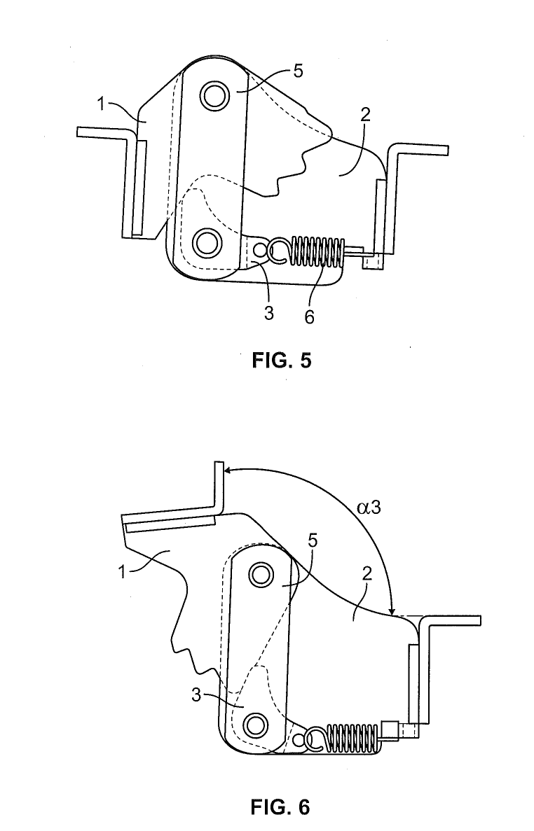

FIG. 5 is a front view of the hinge in a horizontal position according to another example embodiment of the invention;

FIG. 6 is a front view of the hinge in an initial position according to another example embodiment of the invention;

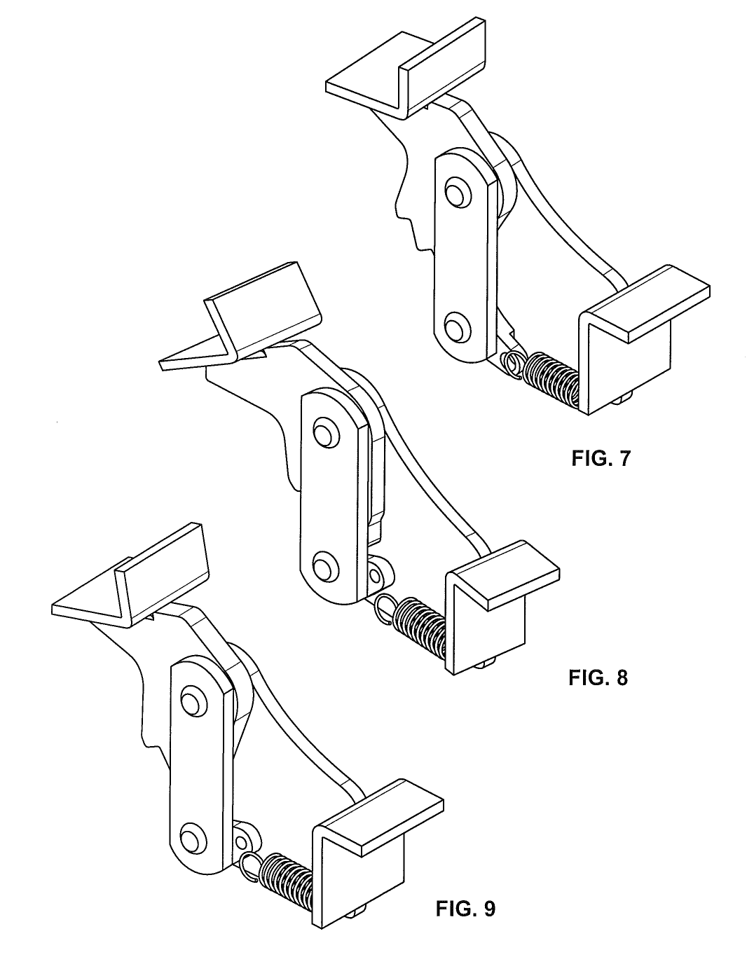

FIG. 7 is a side view of the hinge in an initial position according to another example embodiment of the invention;

FIG. 8 is a side view of the hinge in the first position according to another example embodiment of the invention;

FIG. 9 displays a side view of the hinge in the second position according to another example embodiment of the invention.

### DETAILED DESCRIPTION OF THE INVENTION

The triple-tooth weld-on hinge comprises a cradle plate 1, connector spinal plate 2, crowfoot wrench 3, riveting pin 4, connector plate 5, and spring 6. The cradle plate 1, connector spinal plate 2, and crowfoot wrench 3 are connected through the connector plate 5 and secured with the riveting pin 4. The bottom is joined by the spring 6.

In FIG. 5, the crowfoot wrench 3 is situated in a free position, and the cradle plate 1 and connector spinal plate 2 are horizontal.

In FIG. 3, when the connector spinal plate 2 is turned clockwise, the plate's 2 teeth 7 will slip past the top of the crowfoot wrench 3 and lodge into the plate's 2 groove. With the crowfoot wrench's 3 fixing function, the plate 2 cannot move in a counterclockwise direction. Therefore, it is locked into a first position, i.e., position 1, forming a 105° angle σ1.

In FIG. 4, when the connector spinal plate 2 is turned clockwise, the plate's 2 teeth 7 will slip past the top of the crowfoot wrench 3 and lodge into the plate's 2 groove. With the crowfoot wrench 3 at the top 8 and fixing function at the critical point 9, the plate 2 cannot move in a counterclockwise direction. Therefore, it is locked into a second position, i.e., position 2, forming a 125° angle σ2.

In FIG. 6, when the connector spinal plate 2 is turned clockwise, the plate's 2 teeth 7 will slip past the top of the crowfoot wrench 3; and, in the absence of grooves, the crowfoot wrench 3 will no longer be fixed, allowing the plate 2 to turn counterclockwise, forming a 90° angle σ3.

The connector spinal plate 2 is manufactured from, for example, Mn16 steel plates, and the crowfoot wrench can be manufactured from, for example, agate steel. The steel of each part may be manufactured through a quenching process.

This application claims priority to Chinese patent no. 2010 2 0241902.1 filed in China on Jun. 30, 2010 which is hereby incorporated by reference in its entirety.

While this invention is susceptible of embodiment in many different forms, there are shown in the drawings and will herein be described in detail, examples of the invention with the understanding that the present disclosure is to be considered as an exemplification of the principles of the invention and is not intended to limit the broad aspect of the invention to the examples illustrated.

I claim:

1. A hinge comprising:
a cradle plate,
a connector spinal plate having three teeth,
a crowfoot wrench positioned to engage the teeth of the connector spinal plate;
a set of riveting pins;
a connector plate that connects the cradle plate, the connector spinal plate and the crowfoot wrench via the set of two riveting pins; and,
a spring that secures the crowfoot wrench to the cradle plate.

2. The hinge of claim 1 wherein a range of movement between the cradle plate and the connector spinal plate is between 105 degrees and 125 degrees.
